(19) United States
(12) Patent Application Publication
(10) Pub. No.: US 2002/0027958 A1
(43) Pub. Date: Mar. 7, 2002

(54) Feedback channel signal recovery

(76) Inventor: James C. Kolanek, Goleta, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/887,455

(22) Filed: Jun. 21, 2001

Related U.S. Application Data
(60) Provisional application No. 60/213,728, filed on Jun. 22, 2000.

(51) Int. Cl. H04K 1/02; H04L 25/03; H04L 25/49

(52) U.S. Cl. 375/297; 375/232; 375/296

(57) ABSTRACT

A plant output signal is divided into a number of output frequency subband signals. Each subband signal may be digitized at a sampling rate that need only be sufficiently high to capture the bandwidth of that subband signal. The digitized output subband signals are time-aligned with an estimated output signal that has been derived from a plant input signal. An adaptive equalization process is performed using the time aligned output subband and estimated output signals. This technique may be applied to adaptively equalize the channels of a linear amplification with nonlinear components (LINC) style radio frequency (RF) amplifier.

This non-provisional patent application takes the benefit of the earlier filing date of U.S. provisional application serial No. 60/213,728 filed Jun. 22, 2000 entitled, “Feedback Channel Signal Recovery for an Amplifier”.

### BACKGROUND INFORMATION

This invention is generally related to the field of adaptive equalization and more particularly to techniques for recovering feedback information, for purposes of equalization, in a wideband output signal using a narrow band feedback channel.

Typically, an adaptive control system is one within which an automatic mechanism is used to change the system parameters in a way intended to improve the performance of the system. The adaptive control system can be used in a high power linear amplifier in which an input signal is decomposed into a number of constant amplitude signals which are then amplified by a pair of efficient, possibly non-linear amplifiers. These amplified components are then linearly combined to form a high power replica of the input. Such amplifiers are also known as LINC amplifiers. To better understand the application of the adaptive control system in a LINC amplifier, the architecture of a LINC amplifier is now described.

The LINC amplifier has a LINC modulator which decomposes an input signal into two or more constant-amplitude phase-modulated components. Each component is then amplified in a separate channel, by a phase-preserving high power amplifier (HPA) which may otherwise be non linear. A power combiner is also provided to combine the amplified components of the different channels, resulting in a linearly amplified version of the input signal.

To improve overall linearity, the accuracy of the LINC modulator may be enhanced by implementing it using digital signal processing. Linearity is also improved by balancing the frequency response of the channels in which the components are amplified. This has been done using adaptively controlled digital equalization filters, in one or more of the channels, which compensate the components for any expected imbalance between the channels that might cause distortion at the power combiner output. This technique often uses an adaptive control loop which receives feedback signals from one or more points in the amplifier signal paths including for example, the combiner output, and in response adapts the equalization filters to null the difference between a feedback signal (such as one derived from the combiner output) and a desired output signal (typically derived from the input signal). A difficulty arises in this technique, however, because the bandwidth of the feedback signal in the conventional LINC amplifier is typically much greater than that of the input signal. This typically requires that a very costly, wideband feedback channel be implemented to accurately sample and process the combiner output.

### BRIEF DESCRIPTION OF THE DRAWINGS

The invention is illustrated by way of example and not by way of limitation in the figures of the accompanying drawings in which like references indicate similar elements. It should be noted that references to “an” embodiment in this disclosure are not necessarily to the same embodiment, and they mean at least one.

FIG. 1 shows a block diagram of a LINC amplifier.

FIG. 2 shows a phasor diagram of a pair of LINC modulator output signals.

FIG. 3 depicts the spectral characteristics of an input signal and part of a LINC modulator output component.

FIG. 4 depicts a block diagram of an embodiment of a LINC amplifier with a calibration unit that enables adaptive equalization of the channels.

FIG. 5 shows a time-frequency plot of a feedback channel signal obtained by sequentially sampling a wideband output signal.

FIG. 6 shows an embodiment of the signal processing used within a feedback channel.

FIG. 7 shows a time-frequency plot which illustrates the contents of a feedback buffer at a first conversion stage of the embodiment of FIG. 6.

FIG. 8 shows the contents of the feedback buffer using a time-frequency plot, for the final frequency conversion stage of the embodiment of FIG. 6.

FIG. 9 shows a flow diagram of an embodiment of a feedback channel signal recovery technique.

### DETAILED DESCRIPTION

A feedback channel signal recovery technique is described that effectively processes the spectrum of a wideband output signal using a feedback channel that has limited bandwidth. According to a LINC radio frequency (RF) amplifier embodiment, a wideband RF output signal is divided into a number of smaller subbands. Each subband is in turn translated to an intermediate frequency (IF) band or baseband, and then digitized according to a sampling rate that need only be sufficiently high to capture the bandwidth of that subband. Although some of the spectral information in the original output signal is lost during such conversion, the technique enables the digital processing of a substantial amount of feedback information to control, for instance, a LINC-style RF amplifier using a relatively low cost and low sampling rate A/D converter in the feedback channel.

In the following description, numerous details are set forth in order to provide a thorough description of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

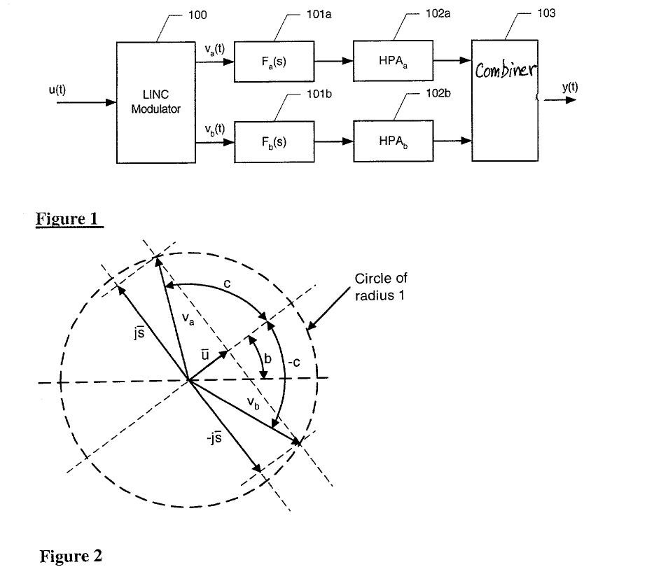

A block diagram of a LINC amplifier that uses the feedback channel recovery process described herein is shown in FIG. 1. Referring to FIG. 1, the LINC amplifier includes a LINC modulator 100, two high power amplifiers (HPAs) 102a and 102b, and a LINC combiner 103. There are two channel frequency response transfer functions Fₐ(s) 101a and F_{b}(s) 101b to represent the combination of all frequency sensitive elements in the amplifier signal paths between the LINC modulator 100 and the combiner 103 (also referred to as amplifier channels). The LINC modulator decomposes the input signal, in this embodiment, into a pair of constant amplitude signals such that their sum reconstitutes the input signal. The input signal u(t) may be a bandlimited, but otherwise arbitrary, signal represented as follows:

u(t)=a(t)e^{jb(t)} (1)

with an amplitude function a(t) and a phase function b(t). In other embodiments, the input signal may be relatively wideband, as compared to the signal processing bandwidth that is available for feeding the adaptive control process. These embodiments will be revisited below once the various embodiments of the feedback channel signal recovery process have been described more fully.

The input signal amplitude function can be normalized as follows:

\overline{u}(t)=\overline{a}(t)e^{jb(t)} (2)

where

$$\overline{a} ( t ) = \{ \begin{matrix}a ( t ) / {A}_{clip} , & a ( t ) \leq {A}_{clip} \\ 1 , & a ( t ) > {A}_{clip}\end{matrix} \qquad ( 3 )$$

and A_{clip} is a clip level imposed on the input signal to implement the decomposition of the input signal by the LINC modulator 100 into two constant amplitude signals vₐ(t) and v_{b}(t), i.e.

vₐ(t)=e^{j(b(t)+c(t))}

v_{b}(t)=e^{j(b(t)-c(t))} (4)

where c(t) is an angle or phase given by

c(t)=cos⁻¹(\overline{a}(t)) (5)

A phasor diagram of the LINC modulator output signals is presented in FIG. 2. This phasor diagram suggests an alternate form for the LINC modulator decomposition, namely

vₐ(t)=\overline{u}(t)+js(t)

v_{b}(t)=\overline{u}(t)−js(t) (6)

where

$$\overline{u} ( t ) = \overline{a} ( t ) {ⅇ}^{j b ( t )} \\ \begin{matrix}s ( t ) = \sqrt{1 - {\overline{a} ( t )}^{2}} {ⅇ}^{j b ( t )} \\ = \frac{\sqrt{1 - {\overline{a} ( t )}^{2}}}{\overline{a} ( t )} \overline{u} ( t )\end{matrix} \qquad ( 7 )$$

Using this notation, the sum of the LINC modulator output signals is

$$\begin{matrix}{v}_{a} ( t ) + {v}_{b} ( t ) = 2 \overline{u} ( t ) \\ \approx \frac{2}{{A}_{clip}} u ( t )\end{matrix} \qquad ( 8 )$$

which is the desired result, i.e. the sum reconstitutes the input signal u(t) multipled by a scalar factor.

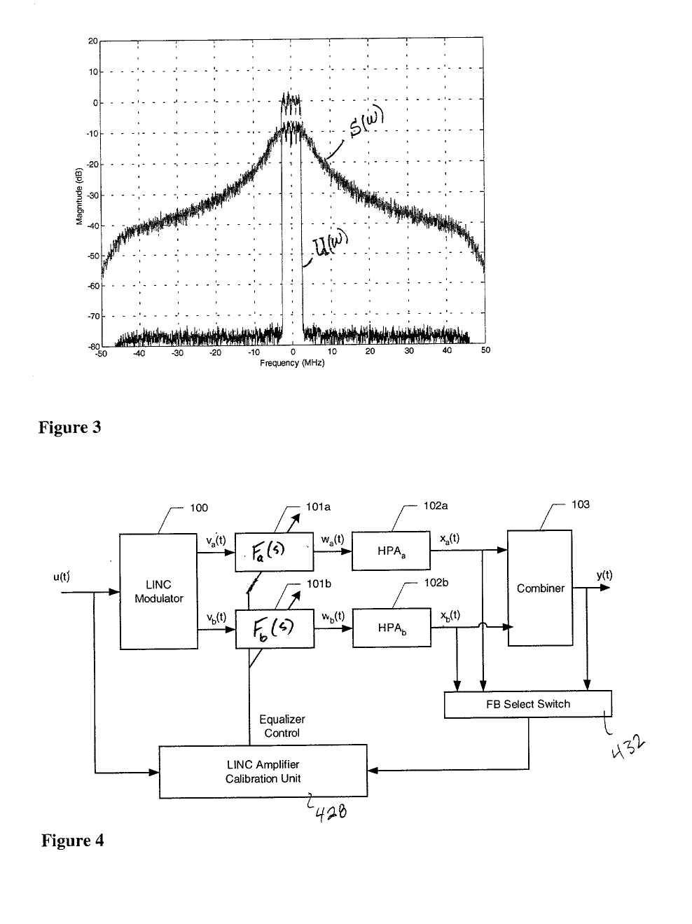

By way of example, FIG. 3 shows the spectral characteristics of the two signals represented in equation (7), namely U(ω) and S(ω), for a case of four adjacent code division multiple access (CDMA) signals. Note the considerable expansion of spectral components of S(ω) relative to that of the input signal U(ω).

In U.S. Pat. No. 6,215,354 (the “'354 Patent”), a closed loop equalization process uses samples of the input and output signals to adaptively control a set of channel equalization filters (also referred to as equalizers) to balance the two channels of the LINC amplifier. A block diagram of this configuration is shown in FIG. 4. Samples from the input and the output are provided to a LINC Amplifier Calibration Unit (LACU) 428. In this embodiment, the samples from the combiner output y(t) and from xₐ(t) and x_{b}(t) in the two amplifier channels are provided through a feedback select switch (FBSS) 432. The LACU 428 processes one or more of these feedback signals along with the input signal to control the two equalizers that are part of Fₐ(s) and F_{b}(s).

The LINC modulator 100 and channel equalization filters may be implemented digitally, using high speed analog to digital converters (ADC) and digital to analog converters (DAC) to provide the interface between the continuous time analog domain and discrete time domain. The LACU 328, if implemented digitally, receives samples of the input signal directly from the input ADC (not shown) and simultaneously from a feedback ADC (not shown) via the FBSS 432. Note that the available signal processing bandwidth, BW, of the ADC and DAC devices is limited by a sample frequency, Fs, and the Nyquist criteria, i.e. BW≦Fₛ/2.

In such a configuration, it is generally, although not necessarily always, the case that the ADC has adequate bandwidth to capture the input signal u(t) but may not have sufficient bandwidth to capture the relatively wideband signal component s(t), which is present in the amplifier channel signals xₐ(t) and x_{b}(t) and in the combiner output signal y(t), before the adaption is complete. See FIG. 3 for an example of the relative spectra of U(ω) and S(ω). For instance, the output signal y(t) which is sampled by the feedback channel may be approximately 60 MHz in width whereas the feedback channel itself (including the feedback ADC) is relatively narrowband and has only, e.g., a 30 MHz processing bandwidth. However, the equalization process needs the entire bandwidth of the amplifier output channels. Accordingly, an approach is described here to use the limited bandwidth of the feedback channel to effectively process a wideband output signal for use in the equalization process.

The following description applies to a wide range of wideband output signals, such as those available from the FBSS 432 including, for instance, xₐ(t), x_{b}(t), and y(t), although for convenience only the symbol y(t) will be used. It is understood therefore that references to y(t) below may refer to a wide range of different wideband signals.

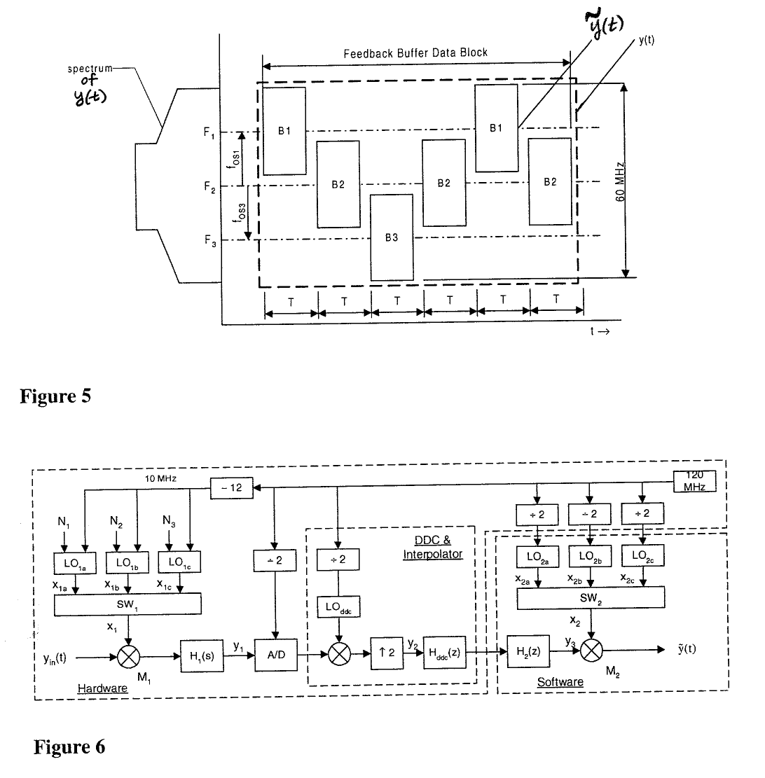

FIG. 5 will help explain an embodiment of the feedback channel signal recovery process. This diagram shows a time-frequency plot of the feedback channel signal obtained by sequentially sampling the wideband RF signal y(t) available from the output of the FBSS 432 in the LINC amplifier of FIG. 4 using a narrow band feedback channel. The rectangular regions, B1, B2, B3 represent frequency regions (also referred to as subbands) observable by the narrow band tunable receiver which is capable of observing only a portion of the output signal spectrum at any instant. Let y(t) be a representative wideband RF signal available at the output of the FBSS and \tilde{y}(t) be the sequentially sampled feedback channel signal provided by the tunable receiver. Input y(t) may be a wideband (e.g. ˜60 MHz) signal which occupies the entire time-bandwidth region indicated.

The feedback channel signal \tilde{y}(t) may be obtained, for example, by sequentially tuning or stepping a local oscillator signal (LO) of a mixer to translate the entire output signal bandwidth to lower frequencies. This embodiment will be further described below in connection with FIG. 6. Note that an alternative here would be to perform the conversions simultaneously and in parrallel, and then have the adaptive equalization process use the subband signals in parallel.

A repetitive tuning pattern is shown in FIG. 5 that centers the feedback channel at three offset frequencies F₁, F₂ and F₃ and dwells for time T at each frequency so that the feedback channel can sample the particular subband during each non-overlapping time interval T. Subbands B₁, B₂ and B₃ indicate the instantaneous bandwidth coverage of the feedback channel. In general, there can be K (two or more) such subbands. Although the following description focuses on dividing the output signal spectrum into three, equal sized portions, the concepts can more generally be applied to two or more portions that need not have equal bandwidths.

In the '354 Patent, a process was described that minimized cost functions having the form

C=∥y−V_{g}(u)g∥ (8.5)

where y is the vector version of the measured feedback signal values y(t), V_{g} is constructed from the measured input signal u(t), and g=[gₐ, g_{b}] is the vector version of the channel response functions to be estimated by minimizing the cost function. The signal V_{g} is constructed such that it is an estimator of the output signal, based on the input signal u(t) and g. That is:

ŷ=V_{g}(u(t))g (9)

The cost function minimization process can be based on any of a number of well known methods of least squares.

It should be noted that in practice, the input signal u(t) used by the adaptive equalization process to derive an estimate of the output signal may contain either the actual real-time information to be processed by the plant into an output signal, or it may contain a ‘training signal’. This training signal may be pre-defined and known to the adaptive equalization process, so that no measurements of the actual plant input signal that carries the information in real-time is necessary.

According to an embodiment of the feedback channel signal recovery process, a process of obtaining suitable measurements of an output signal (e.g. y(t) in the LINC amplifier of FIG. 4) using a bandlimited mechanism is described herein. These measurements are incorporated into an adaptive equalization process. The equalization process may be a modified version of a process described in the '354 Patent, or it may be another type of process used for adaptive control of a generic plant.

Sequential Sampled Signal Representation

A set of gating functions (also referred to as ‘weighting’ functions) will be used to generate an analytical expression for \tilde{y}(t), the feedback signal obtained using the narrowband feedback channel. First, let qₖ(t) be a gating function which defines the temporal gating for subband k. In one form, qₖ(n) has value 1 when the k-th subband is sampled and zero otherwise. Next, consider a spectral gating function rₖ(n) such that its Fourier transform Rₖ(f) defines the spectral gating for subband k. Likewise, Rₖ(f) can have value 1 when the k-th subband is sampled and zero otherwise. Then, assuming K subbands, the feedback signal may be written as a sum of K subband signals as follows:

$$\begin{matrix}\tilde{y} ( t ) = {\sum }_{k = 1}^{K} {q}_{k} ( t ) \cdot y ( t ) * {r}_{k} ( t ) \\ = {\sum }_{k = 1}^{K} {\tilde{y}}_{k} ( t )\end{matrix} \qquad ( 10 )$$

The following vector-matrix relations may also be defined:

=[y(1), y(2), . . . , y(Nₛ)]^{t}

ŷ=[ŷ(1), ŷ(2), . . . , ŷ(Nₛ)]^{t} (11)

Qₖ=diag([qₖ(1), qₖ(2), . . . , qₖ(Nₛ)])

Rₖ=diag([r_{kf}(1), r_{kf}(2), . . . , r_{kf}(N_{f})])

where y(n), ŷ(n), and qₖ(n) are discrete time domain sequences, while r_{kf}(n) is a frequency domain sequence. Note that y(n) may be viewed as a digitized version of a corresponding time domain signal y(t). Also, note that r_{kf}(n) used here is equivalent to the spectral weighting component Rₖ(f) defined above.

Let D be a N_{f}×Nₛ Discrete Fourier Transform (DFT) matrix. Then, the matrix/vector form of the subband sampled signals defined in (10) may be given by

\tilde{y}ₖ=D⁻¹BₖDQₖy (12)

where D⁻¹=D^{H} is the inverse DFT. Since y(t) (the output signal) is not equal to the feedback signal \tilde{y}(t) (the sum of K output subband signals), the cost function used in the equalization process of the '354 Patent should be modified to use this available feedback signal to control the equalizers. According to an embodiment of the feedback signal recovery process herein, the following revised cost function may be used:

$$\tilde{C} = {\sum }_{k = 1}^{K} ‖ {\tilde{y}}_{k} - {\tilde{V}}_{gk} ( {u}_{k} ) g ‖ \qquad ( 13 )$$

where \tilde{V}_{gk}(uₖ)g represents the estimated values of y subject to the same time and frequency gating functions that the actual y was subjected to obtain the subband signals \tilde{y}ₖ(n). Note the intent here is to use a form of y (actual) and ŷ (estimate) which have the same time-frequency pattern. Since \tilde{y}(n) is provided by the feedback channel, the estimate ŷ is made to have the same time-frequency structure as \tilde{y}(n). This may be accomplished by setting

\tilde{V}_{gk}(uₖ)=D^{H}BₖDQₖV_{g}(u) (14)

This expression (15) is equivalent to a weighted version of the original cost function given in equation (8b) above. Substituting from equation (13) into equation (14) gives:

$$\begin{matrix}\tilde{C} = {\sum }_{k = 1}^{K} ‖ {D}^{H} {R}_{k} {DQ}_{k} y - {D}^{H} {R}_{k} {DQ}_{k} {V}_{h} g ‖ \\ = {\sum }_{k = 1}^{K} {‖ y - {V}_{g} g ‖}_{{Q}_{k}^{*} {D}^{*} {R}_{k}^{*} {R}_{k} {DQ}_{k}} \\ {=}^{Δ} {\sum }_{k = 1}^{K} {‖ y - {V}_{g} g ‖}_{{w}^{H} w}\end{matrix} \qquad ( 15 )$$

An example of a least squares solution to compute the vector g that minimizes the cost function given in equation (15) is as follows. Let Bₖ be a weighting matrix where Bₖ=Wₕ^{H}Wₕ=Qₖ*D*Rₖ*RₖDQₖ. A gradient may be determined as follows

$$\begin{matrix}\frac{\partial \tilde{C}}{\partial g} = \frac{\partial }{\partial g} {\sum }_{k = 1}^{K} {‖ y - \hat{V} g ‖}_{{B}_{k}} \\ = {\sum }_{k = 1}^{K} [ - 2 {\hat{V}}^{*} {B}_{k} y + 2 {\hat{V}}^{*} {B}_{k} \hat{V} g ] \\ = {\sum }_{k = 1}^{K} - 2 {\hat{V}}^{*} {B}_{k} [ y - \hat{V} g ]\end{matrix} \qquad ( 16 )$$

Setting the gradient to zero provides the “matrix inversion” solution for g:

g=R⁻¹Py (17)

where

$$R = {\sum }_{k = 1}^{K} {\hat{V}}^{*} {B}_{k} \hat{V} = {\hat{V}}^{*} [ {\sum }_{k = 1}^{K} {B}_{k} ] \hat{V} = {\hat{V}}^{*} B \hat{V} \\ P = {\sum }_{k = 1}^{K} {\hat{V}}^{*} {B}_{k} = {\hat{V}}^{*} [ {\sum }_{k = 1}^{K} {B}_{k} ] = {\hat{V}}^{*} B \qquad ( 18 )$$

If the full band data set for \tilde{y}(n) were available, then the solution would be given by setting B=I (the identity matrix). The equations (18) and (19) thus give a solution for the channel transfer function g, which is then used as part of the adaptive control loop to update the plant control paramters.

Regarding the gating functions, these may also be configured to weight measurements of plant input and output signals to remove unwanted time and/or frequency components from measured data. For instance, the gating functions may be designed to remove switching transients and filter edge distortion caused by the process that divides the output signal into the subband signals.

Feedback Channel Signal Processing and Signal Recovery

FIG. 6 shows an embodiment of the signal processing employed within the feedback channel in which a combination of hardware and digital signal processing (DSP) software is used to generate a generic feedback signal \tilde{y}(t). The section indicated as hardware may be contained within radio frequency/intermediate frequency (RF/IF) and digital signal processing assemblies. This includes the first set of local oscillators (LOs) LO₁ₐ, LO_{1b}, and LO_{1c}, LO select switch SW₁, mixer M₁, IF filter H₁(s), A/D converter, and the Digital Down Converter (DDC). The DSP software includes, in this embodiment, digital filter H₂(z), a second set of LOs LO₂ₐ, LO_{2b}, and LO_{2c}, LO select switch SW₂, and mixer M₂. The interface between the hardware and the software is implemented using a data buffer (not shown) that captures blocks of samples from the Digital Down Converter (DDC) which are transferred to the DSP. Other implementations of the signal processing are possible and within the grasp of one of ordinary skill in the art.

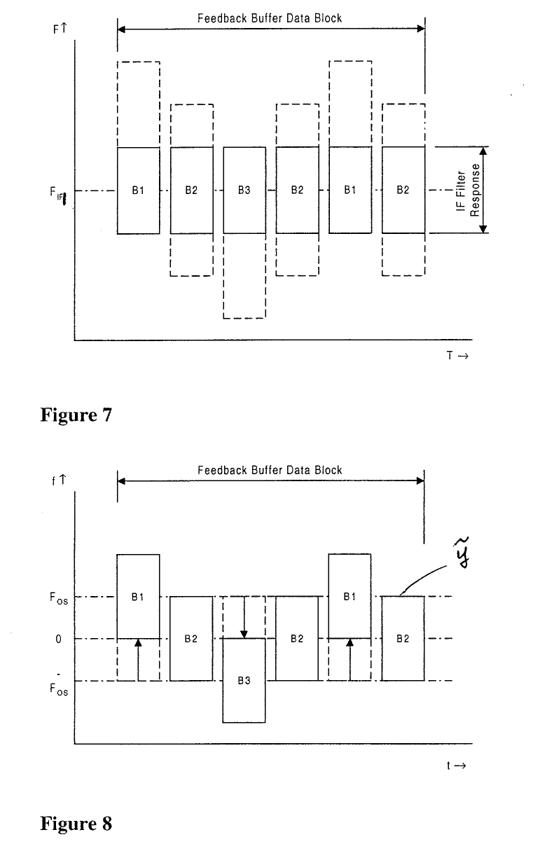

The signal yᵢₙ(t) provided to the feedback channel is translated by the mixer M₁ using the k-th LO signal x₁ₖ(t), k=1, 2, . . . , applied through the LO select switch SW₁. The various stable LO signals are, in this embodiment, sequentially selected by the LO select switch SW₁ and applied to the mixer M₁ to perform the frequency conversion shown in FIG. 7. Referring to FIG. 7, the dotted lines represent the signal yᵢₙ(t) after it has been moved to position various portions of its wideband spectrum within the narrow pass band of IF filter H₁. Consequently, only the portions of the signal contained in the pass band of H₁ (shown in solid lines) are passed to the A/D as signal y₁(t) (see FIG. 6).

Signal y₁(t) is then sampled by the A/D converter to produce sampled or discrete time versions y₁(nTₛ)=y₁(n). The IF frequency, and center of filter H₁, may be selected to be (2n+1)Fₛ/4 where Fₛ is the sample frequency of the A/D and n=0, 1, 2, etc. For an Fₛ of 60 MHz and n=0, the IF frequency is 15 MHz. This provides a filter bandwidth, and also a Nyquist bandwidth, of 30 MHz. The filter H₁ may alternatively be configured for other other IF frequencies, depending on the sampling capabilities of the A/D converter and the bandwidth of yᵢₙ(t).

Once digitized, the subband signals may be further frequency translated and/or oversampled to make subsequent processing more convenient as well as more accurate. In the embodiment shown in FIG. 6, the digitized subband signals are further downcoverted, using digital techniques, to enable more convenient processing at baseband (e.g. zero center) frequencies. A Digital Down Converter (DDC) includes, in this embodiment, a digital LO and mixer, a x2 interpolator and low pass filter H_{ddc}(z). The output of the DDC mixer shifts the signal by Fₛ/4 converting the signal to a complex baseband signal for convenience of processing.

In order to accommodate the expanded bandwidth of the synthesized feedback signal \tilde{y}(t) (which includes a sum of the individual subband signals—see equation (10) above), the x2 interpolator increases the sample rate by, in this embodiment, a factor of 2. This may be done by, for example, adding zeros between samples. The filter, H_{ddc}, then removes signal components at the original sample rate leaving only the baseband signal but at twice the sample rate. In this case, the resulting sample rate is 120 MHz. The DDC filter may be implemented in hardware as, for instance, a Finite Impulse Response (FIR) filter. Other frequency translation and oversampling techniques known to those of ordinary skill in the art may alternatively be used.

After conversion to complex basedband and oversampling, the subband signals are repositioned back to their original, relative positions in the spectrum of yᵢₙ(t) as in FIG. 5. An embodiment of this repositioning is depicted in FIG. 8. Referring to FIG. 8, note that some overlap in frequency is preferred between the subbands. The repositioning may be performed prior to the subband signals (in their combined form as the feedback signal \tilde{y}(t)) being processed by the adaptive control process. Referring back to FIG. 6, a second set of LOs LO₂ₐ, LO_{2b}, and LO_{2c} are used to reposition the subbands back to their original relative positions as shown in FIG. 8. The k-th LO₂ₖ signal, x₂ₖ(n), is selected by LO switch SW₂ and applied to mixer M₂. The frequencies of k-th LO₂ₖ are mirror images of the k-th LO₁ₖ signal used in the first conversion stage. Note that the H₂ filter if used may be implemented in DSP software to provide additional compensation for any of the analog filters in the preceding signal processing path as may be required. For example, H₂ can provide compensation of group delay variations inherent in filter H₁(s).

Note that all LOs shown in FIG. 6 are either locked to a common reference or divided from the common reference. This ensures that coherency is maintained in the sampling process and allows the subband signals to be translated back to their original locations to form \tilde{y}(t) as described immediately above. In the embodiment of FIG. 6, the common reference is at 120 MHz. Because of the common reference, all frequencies are known exactly. However, the phase of the first set of LOs may generally be unknown. Since yᵢₙ(t) normally contains a significant component of u(t) obtained from the input channel, the phase of these LOs can be estimated from a measured data set taken from the modulator output signals using conventional estimation techniques similar to that described for estimating the transfer function coefficients for the g vectors.

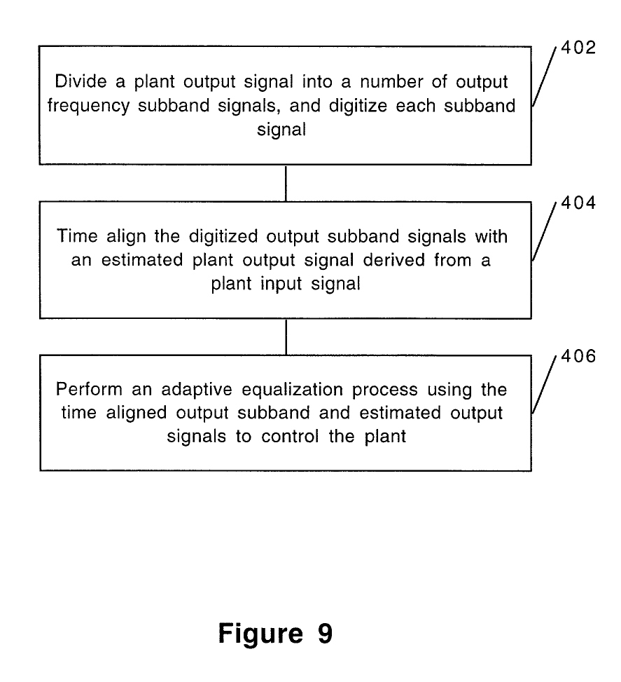

A method for adaptive equalization of a plant, such as a LINC amplifier, is described according to the flow diagram of FIG. 9. This method may be implemented in a spectrum sampling receiver, also referred to as a tunable receiver, such as the one described above in connection with FIG. 6 and subsequent figures. Beginning with operation 402, a plant output signal is divided into a number of output frequency subband signals. Each output subband signal may then be digitized for digital processing purposes. The output subband signals are time aligned with estimated output signals that have been derived based on an input signal to the plant (operation 404). An adaptive equalization process is performed, using the time aligned output subband and estimated output signals, to control the plant (operation 406). The plant incorporates a controllable mechanism for modifying its transfer functions. In digital form, the mechanism may include a FIR filter with programmable taps, such as the ones used in the channel equalizers of the LINC amplifier described in the '354 Patent.

If the input signal is also wideband relative to an input channel processing bandwidth, then the input signal may also be divided into frequency subband signals that can be time aligned with their corresponding output subband signals. In that case, the cost function of the adaptive equalization process in the '354 Patent may need to be further modified to use a weighted version of the input signal. In addition, the output subband signals should also be frequency aligned with respect to the input subband signals. In other words, the same frequency range should be selected for a given pair of corresponding input and output subband signals. This promotes coherency in the adaptive equalization process.

To summarize, various embodiments of a feedback signal recovery technique to use with an adaptive equalization process have been described. It will however be evident that various modifications and changes may be thereto without departing from the broader spirit and scope of the invention as set forth in the appended claims. For instance, although some of the above-described embodiments include an A/D converter in the feedback channel, as well as perhaps one for digitizing the input signal, the feedback signal recovery technique may alternatively be applied to an analog feedback channel and an analog input processing channel. In addition, some embodiments includea LINC amplifier under adaptive equalization. However, the feedback signal recovery technique can be applied to other types of plants under adaptive equaliztion as well. The specification and drawings are accordingly to be regarded in an illustrative rather than a restrictive sense.

What is claimed is:

1. A method comprising:
dividing a plant output signal into a plurality of output subband signals;
digitizing the first output subband signal over a first time interval;
digitizing the second output subband signal over a second time interval;
time aligning the digitized output subband signals in the first and second intervals with an estimated output signal derived from a plant input signal; and
performing an adaptive equalization process using the time aligned output subband and estimated output signals.

2. The method of claim 1 further comprising:
translating the first output subband signal to a first lower frequency prior to digitizing; and
translating the second output subband signal to a second lower frequency prior to digitizing.

3. The method of claim 2 wherein the first and second lower frequencies are the same and the translating of the first and second subband signals is performed by mixing the first and second subband signals with oscillator signals that are locked to the same oscillator reference signal

4. The method of claim 1 wherein the plant is a LINC RF amplifier.

5. The method of claim 1 wherein the first and second intervals do not overlap.

6. An apparatus comprising:
an adaptive equalizer coupled to enhance a quality of an output signal; and
a tunable receiver to select different ones of a plurality of output subband signals that make up essentially an entire spectrum of the output signal, and in response provide as feedback to the adaptive equalizer samples of the selected output subband signals to cover essentially the entire spectrum of the output signal, the receiver having a bandwidth less than that of the output signal.

7. The apparatus of claim 6 wherein the receiver is further capable of translating selected output subband signals to a lower frequency prior to digitizing said selected output subband signals.

8. The apparatus of claim 6 wherein the receiver and the equalizer are further capable of time aligning digitized selected output subband signals with an estimated output signal and using the time aligned output subband and estimated output signals to perform an adaptive equalization process.

9. The apparatus of claim 6 wherein the receiver includes an A/D converter coupled to digitize the output signal and a tunable digital filter coupled to filter the digitized output signal and in response provide selected ones of the plurality of output subband signals.

10. The apparatus of claim 6 further comprising:
a linear amplifier having a modulator to generate a pair of constant-amplitude phase-modulated components in response to the input signal, a pair of channels which include (1) a pair of power amplifiers coupled to amplify the components, respectively, and (2) the adaptive equalizer coupled to make amplitude and phase corrections in or both of the components, and a combiner to provide the output signal by combining the amplified components.

11. The apparatus of claim 8 wherein the receiver includes a mixer coupled to translate the output subband signals using a plurality of oscillator signals that are locked to the same oscillator reference signal.

12. An appartus comprising:
means for modifying a transfer function of a plant;
means for dividing an output signal of the plant into a pluality of frequency subband signals;
means for weighting the plurality of frequency subband signals to remove unwanted transient and spectral signal components; and
means for adaptively controlling the plant transfer function modifier means based on processing the weighted plurality of frequency subband signals to enhance a plurality of performance parameters of the plant.

13. The apparatus of claim 12 wherein the dividing means includes means for sequentially measuring each of the plurality of subband signals.

14. The apparatus of claim 12 further comprising:
means for frequency down converting the plurality of subband signals prior to processing by the adaptive control means.

15. The apparatus of claim 12 further comprising:
means for digitizing the plurality of subband signals prior to processing by the adaptive control means, said adaptive control means being capable of digitally processing the plurality of subband signals to control the plant transfer function modifier means.
